(19) United States
(12) Patent Application Publication
(10) Pub. No.: US 2009/0039794 A1
(43) Pub. Date: Feb. 12, 2009

(54) MINIATURE LIGHT BULB FOR RANDOM HIGH-LOW TWINKLE IN SERIES-WIRED LIGHT STRING

(76) Inventor: John L. Janning, Bellbrook, OH (US)

Correspondence Address: DICKSTEIN SHAPIRO LLP, 1825 EYE STREET NW, Washington, DC, 20006-5403, US

(21) Appl. No.: 12/247,975

(22) Filed: Oct. 8, 2008

Related U.S. Application Data
(63) Continuation-in-part of application No. 12/029,329, filed on Feb. 11, 2008.
Application No. 12/029,329 is a continuation-in-part of application No. 11/542,184, filed on Oct. 4, 2006, now Pat. No. 7,342,327.
Application No. 11/542,184 is a continuation of application No. 11/283,717, filed on Nov. 22, 2005.
Application No. 11/283,717 is a continuation of application No. 10/891,094, filed on Jul. 15, 2004, now Pat. No. 7,042,116.
Application No. 10/891,094 is a continuation of application No. 10/364,526, filed on Feb. 12, 2003, now Pat. No. 6,765,313.
Application No. 10/364,526 is a continuation of application No. 10/061,223, filed on Feb. 4, 2002, now Pat. No. 6,580,182.
Application No. 10/061,223 is a continuation of application No. 09/526,519, filed on Mar. 16, 2000, now abandoned.
Application No. 09/526,519 is a division of application No. 08/896,278, filed on Jul. 7, 1997, now abandoned.
Application No. 08/896,278 is a continuation of application No. 08/653,979, filed on May 28, 1996, now abandoned.
Application No. 08/653,979 is a continuation-in-part of application No. 08/560,472, filed on Nov. 17, 1995, now abandoned.
Application No. 08/560,472 is a continuation-in-part of application No. 08/494,725, filed on Jun. 26, 1995, now abandoned.
(60) Provisional application No. 61/132,118, filed on Jun. 16, 2008.
(60) Provisional application No. 61/133,165, filed on Jun. 26, 2008.

(51) Int. Cl. H05B 39/04

(52) U.S. Cl. 315/186; 315/309

(57) ABSTRACT

A flasher bulb including a thermal shorting element that alternately shorts and opens only a portion of the bulb filament, thus causing the flasher bulb to produce an alternating high-low illumination. When a plurality of such flasher bulbs are placed in the sockets of a series-wired light string, they cause the light string to exhibit a random high-low twinkle.

### CROSS-REFERENCE TO RELATED APPLICATIONS

This application claims priority to U.S. provisional application Ser. No. 61/132,118, filed Jun. 16, 2008 and U.S. provisional application Ser. No. 61/133,165, filed Jun. 26, 2008.

This application is a continuation-in-part of application Ser. No. 12/029,329, filed Feb. 11, 2008, which is a continuation-in-part of application Ser. No. 11/542,184, filed Oct. 4, 2006, now U.S. Pat. No. 7,342,327, which is a continuation of application Ser. No. 11/283,717, filed Nov. 22, 2005, which is a continuation of U.S. Ser. No. 10/891,094, filed Jul. 15, 2004, now U.S. Pat. No. 7,042,116, which is a continuation of application Ser. No. 10/364,526, filed Feb. 12, 2003, now U.S. Pat. No. 6,765,313, which is a continuation of application Ser. No. 10/061,223, filed Feb. 4, 2002, now U.S. Pat. No. 6,580,182, which is a continuation of application Ser. No. 09/526,519, filed Mar. 16, 2000, now abandoned, which is a division of application Ser. No. 08/896,278, filed Jul. 7, 1997, now abandoned, which is a continuation of application Ser. No. 08/653,979, filed May 28, 1996, now abandoned, which is a continuation-in-part of application Ser. No. 08/560,472, filed Nov. 17, 1995, now abandoned, which is a continuation-in-part of application Ser. No. 08/494,725, filed Jun. 26, 1995, now abandoned, each of which are incorporated herein by reference.

### BACKGROUND OF THE INVENTION

One of the most common uses of light strings is for decoration and display purposes, particularly during Christmas and other holidays, and more particularly for the decoration of Christmas trees, and the like. Probably the most popular light set currently available on the market, and in widespread use, comprises one or more strings of fifty miniature light bulbs each, with each bulb typically having an operating voltage rating of 2.5 volts, and whose filaments are connected in an electrical series circuit arrangement.

Random twinkling of Christmas lights is a desirable feature in decorative lighting, including the series-wired light strings described above. However, the use of a standard flasher bulb in a series-wired light string containing 50 lights causes the entire light string to go off and on as the flasher bulb opens and closes the circuit. This type of flashing is not a real or ‘smooth’ type of twinkle—if one could even call it that.

The parent patents of the present application, upon which priority is claimed, disclose a method of obtaining true random twinkling in series-wired light strings by using voltage responsive shunts 22-31 in parallel with the wire leads of flasher bulbs 12-21 (see FIG. 1). Thus, when a flasher bulb opens in such a series-wired light string with an AC voltage connected across terminals 10, 11, the voltage responsive shunt across the bulb filament—generally inside of the bulb socket—allows current through the light string to continue uninterrupted keeping the remaining bulbs in the light string operating properly.

Random on/off twinkling in a series-wired light string is pleasing, but it would be desirable to provide random twinkling at various levels of illumination—i.e., high-low twinkling in a series-wired light string.

### SUMMARY OF THE INVENTION

In accordance with the present invention, a new and novel flasher light bulb is provided that produces high-low random twinkle, whereby the flashing of the flasher bulb does not open or close the current passing through the filament of the flasher bulb, as in the prior patents, but instead causes only a portion of a bulb filament to short out and reopen as the thermal shorting element inside of the flasher bulb shorts and opens. This action causes the illumination of the bulb to change from one illumination level to another—producing a high-low random twinkle effect.

The amount of brightness differential between the “high” and “low” illumination of the flasher bulb is determined by the amount of bulb filament that is shorted out when the thermal element inside the bulb is in the closed position. In the preferred embodiment of the invention, for example, 50 percent of the bulb filament is shorted out when the thermal element closes. To produce an effect in which the flasher bulb twinkles brighter than the other bulbs in the light string, the flasher bulb filament can be formed as a double filament, so that the portion of the filament that still passes current and produces illumination upon closure of the thermal element is same as the filament of the other light bulbs in the string, and when the thermal element opens, the illuminated filament is equivalent to a double filament, producing twice the light of other standard bulbs in the string.

Advantageously, since the high-low flasher light bulb of the present invention never turns off completely, it can incorporate internal shunt wiring as described in parent application Ser. No. 12/029,329, filed Feb. 11, 2008, the disclosure of which is incorporated by reference, to keep the string operating in the event of a failure of the flasher bulb.

Other features and advantages of the present invention will become apparent when the following description is read in conjunction with the accompanying drawings.

### BRIEF DESCRIPTION OF THE DRAWINGS

FIG. 1 is an electrical schematic diagram of a series-wired light string employing a conventional flasher bulb;

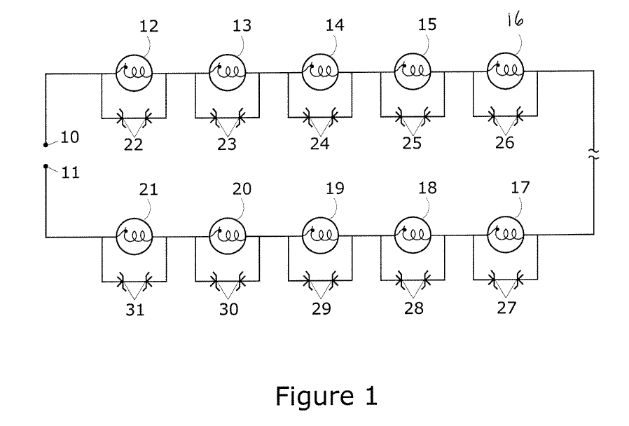

FIG. 2 is electrical schematic diagram of a first embodiment of the flasher bulb of the present invention; and

FIG. 3 is an electrical schematic diagram of a second embodiment of the flasher bulb of the present invention.

### DESCRIPTION OF THE PREFERRED EMBODIMENT

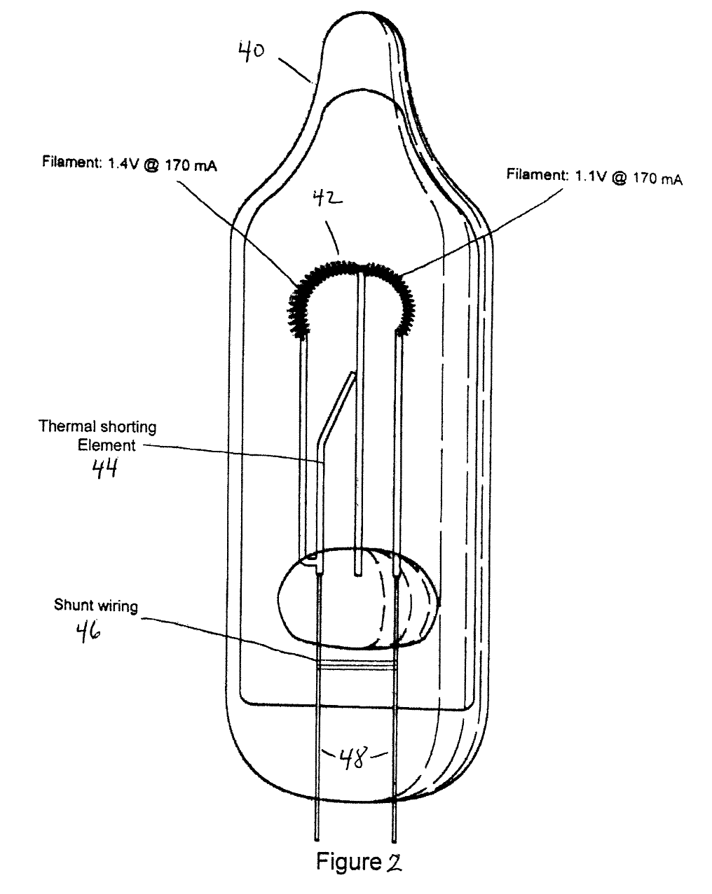

With reference to the schematic diagram in FIG. 2, the novel high-low flasher light bulb 40 of the present invention is provided with a filament 42 that is only partly shorted out as the thermal element 44 closes. Thus, the flashing of the flasher bulb 40 does not open or close the circuit in a series-wired light string, as in the prior art, but instead causes only a portion of a bulb filament to alternately short out as the thermal shorting element inside of the flasher bulb shorts part of the lamp filament. This action causes the illumination of the bulb to change from one illumination level to another—as a high-low random twinkle.

The operation of the present invention is simple. The normal operation of a flasher bulb is to provide current to the filament of a miniature light bulb through a thermal element in contact with a filament lead wire. As the current flows through this thermal element, it begins to heat. This heating causes the thermal element to pull away from the filament lead wire, thus, opening the electrical circuit. Since current no longer flows through the thermal element, it cools and returns to contact the filament wire once again causing the flasher bulb to illuminate again and the thermal element to begin warming again. Thus, the cycle is repeated.

In the high-low random twinkle bulb 40 of the present invention, shown in FIG. 2, the operation is similar except only a portion of the filament 42 is shorted out by the periodic closure of the thermal element 44. Therefore, it can be seen that the bulb 40 is never fully extinguished, even when the thermal element 44 opens.

Since the current in a series-wired light string is the same throughout the string, when approximately half of the filament is shorted out in a high-low bulb of the present invention, there is little change in the illumination of the remaining bulbs in the string. Placing several of the flasher bulbs of the present invention in a light string will provide for a pleasing high-low random twinkle without affecting the remaining bulbs in the string. For example, if a 50 light string contained four of such flasher bulbs, the largest change in voltage across the remaining 46 bulbs would only be approximately one-tenth of a volt per bulb—and—that is only if all of the four flasher bulbs were shorted at the same time. Bulbs in a typical 50 light string are rated at 2.5 volts each. When a 50 light string is operated at 120 VAC, each bulb receives an average of 2.4 volts each.

The amount of brightness differential desired will determine how much of the bulb filament is shorted out. In a preferred embodiment, approximately 50 percent of the bulb filament is shorted out, but more of the filament may be shorted out for a greater brightness differential.

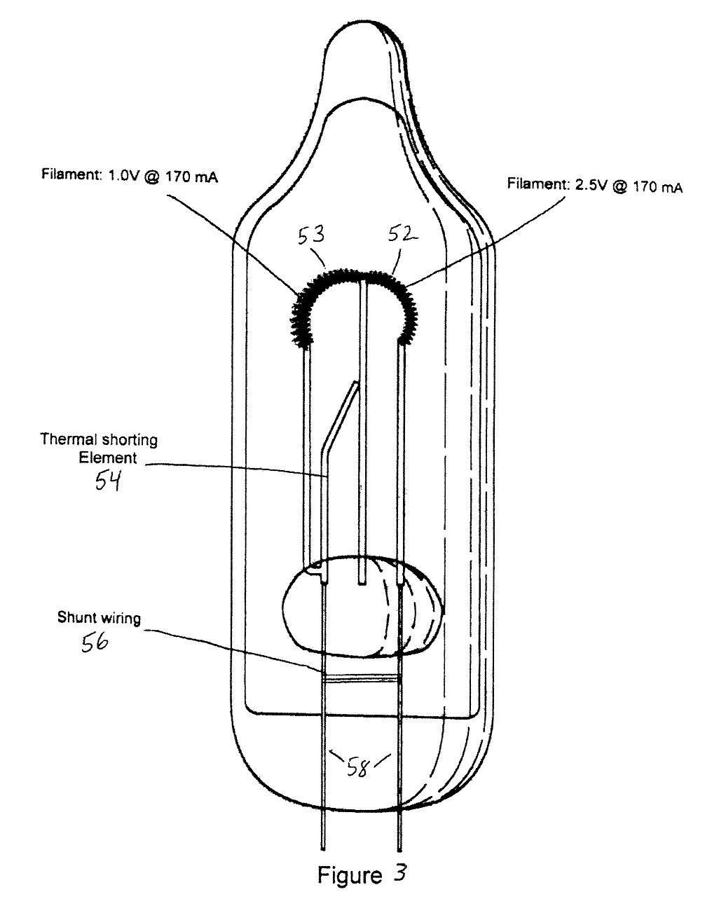

Another type of ‘twinkle’ using the method of the present invention of opening and closing of the thermal element of a flasher bulb is shown in FIG. 3 where the initially turned on filament 52 is the same as the filament in the other bulbs in a 50 bulb light string, i.e. operating at 2.5 volts with a current consumption of approximately 170 milliamperes. As the thermal element 54 opens, another filament 53 is added to the series-wired circuit. This configuration could be considered a two-filament flasher bulb or a “center tapped” filament inside the bulb. This type of operation could be called “Twinkle Bright” since the flasher bulb changes state from the same brightness of other bulbs to an increased brightness.

Advantageously, since the flasher bulb of the present invention never turns off completely, shunt wiring 46 and 56, as shown in FIGS. 2 and 3, can be incorporated in the flasher bulb to ensure continued operation of the light string in the event a flasher bulb fails.

The shunt wiring 46, 56 is a wire wrapped a few times around the two posts 48, 58 inside the bulb. The shunt wiring contains a coating that gives it a fairly high resistance until the flasher bulb filament bums out. If this occurs, the full line voltage appears across the leads of the flasher bulb (upon failure of a shunt located in a socket, if one exists) and hence across the shunt wiring. If that starts to happen, when the voltage rises up to 40 volts or so, the oxide coating on the shunt wiring breaks down and the shunt wiring gets welded to the bulb input terminals. This causes the shunt wiring to act as a shunt, shorting the flasher bulb and enabling continued operation of the light string.

In the case of the socket shunt operating correctly, if one exists, and the flasher filament intact, there is no current flowing through the shunt wiring, and it does not act as a shunt. Thus, in reality, there is no shunt internal to the flasher bulb until it connects by the oxide coated wire breaking down and causing the shunt wire to connect—which normally takes about 40 volts. The 40 volts could only appear across the shunt wiring in a set with shunts in the socket when such a shunt would fail. There could never be a situation where both shunts would be activated at the same time. The shunt wiring in the bulb acts as a shunt only if and when the shunt in the socket (if provided) fails and opens up.

Having so described and illustrated the principles of my invention in a preferred embodiment, it is intended, therefore, in the annexed claims, to cover all such changes and modifications as may fall within the scope and spirit of the following claims.

What is claimed as new and desired to be protected by Letters Patent of the United States is:

1. A series-wired light string, comprising:
a plurality of light bulbs including a plurality of flasher light bulbs; and
a plurality of light sockets, each light socket of the plurality of light sockets adapted to receive at least one of the plurality of light bulbs;
wherein the flasher bulbs each include a filament and a thermal element that moves alternately between an open position and a closed position as the thermal element heats and cools,
wherein, when the thermal element is in the closed position, a portion of the filament is shorted out, such that only a portion of the filament carries current and is illuminated, whereby the filament produces light of a first brightness, and
wherein, when the thermal element moves to the open position, the entire filament carries current and is illuminated, whereby the filament produces light of a second brightness higher than the first brightness,
thereby causing the flasher light bulbs of the series-wired light string to produce illumination of a high and low brightness at different times to cause the light string to exhibit a twinkling effect.

2. A series-wired light string as recited in claim 1, wherein the portion of the filament shorted out is approximately 20 to 70%.

3. A series-wired light string as recited in claim 1, wherein the filament in the flasher bulbs is a double filament relative to the filament in non-flasher light bulbs of the series-wired string, such that the flasher bulbs switch from producing a brightness equal to the non-flasher bulbs to a brightness higher than the non-flasher bulbs.

4. A series-wired light string as recited in claim 1, wherein the flasher bulbs are provided with internal shunts.

5. A method of operating a series-wired light string comprising a plurality of light bulbs including a plurality of flasher light bulbs, and a plurality of light sockets, each light socket of the plurality of light sockets adapted to receive at least one of the plurality of light bulbs; wherein the flasher bulbs each include a filament and a thermal element that moves alternately between an open position and a closed position as the thermal element heats and cools, wherein, when the thermal element is in the closed position, a portion of the filament is shorted out, such that only a portion of the filament carries current and is illuminated, whereby the filament produces light of a first brightness, and wherein, when the thermal element moves to the open position, the entire filament carries current and is illuminated, whereby the filament produces light of a second brightness higher than the first brightness, thereby causing the flasher light bulbs of the series-wired light string to produce illumination of a high and low brightness at different times to cause the light string to exhibit a twinkling effect.

6. A method of operating a series-wired light string as recited in claim 5, wherein the thermal element shorts out approximately 20 to 70% of the filament when the thermal element is in the closed position.

7. A method of operating a series-wired light string as recited in claim 5, wherein the filament in the flasher bulbs is a double filament relative to the filament in non-flasher light bulbs of the series-wired string, such that the flasher bulbs switch from producing a brightness equal to the non-flasher bulbs to a brightness higher than the non-flasher bulbs.

8. A flasher bulb for producing alternately high and low illumination, comprising:
a filament; and
a thermal element that moves alternately between an open position and a closed position as the thermal element heats and cools,
wherein, when the thermal element is in the open position, the entire filament carries current and is illuminated, whereby the filament produces light of a first brightness, and
wherein, when the thermal element moves to the closed position, a portion of the filament is shorted out, such that only a portion of the filament carries current and is illuminated, whereby the filament produces light of a second brightness, which is lower than the first brightness, and
thereby causing the flasher light bulb to alternately produce illumination of a high and low brightness.

9. A flasher bulb as recited in claim 8, wherein the portion of the filament shorted out is approximately 20 to 70%.

10. A flasher bulb as recited in claim 8, further comprising an internal shunt.
